(19) United States
(12) Patent Application Publication
(10) Pub. No.: US 2005/0232634 A1
(43) Pub. Date: Oct. 20, 2005

(54) Undersea optical transmission system employing low power consumption optical amplifiers

(76) Inventors: Stephen G. Evangelides JR., Red Bank, NJ (US); Michael J. Neubelt, Little Silver, NJ (US); Jay P. Morreale, Summit, NJ (US); Mark K. Young, Monmouth Junction, NJ (US); Jonathan A. Nagel, Brooklyn, NY (US); David S. DiVincentis, Flanders, NJ (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 11/091,740

(22) Filed: Mar. 28, 2005

Related U.S. Application Data
(60) Provisional application No. 60/557,343, filed on Mar. 29, 2004.

(51) Int. Cl. H04B 10/00

(52) U.S. Cl. 398/105

(57) ABSTRACT

An undersea WDM optical transmission system is provided. The system includes first and second land-based cable stations, at least one of the cable stations includes power feed equipment (PFE) supplying electrical power to the cable at a voltage of no more than about 6 kv or less. The PFE is located in at least one of the cable stations. The system also includes an undersea WDM optical transmission cable having a length corresponding to those required in the undersea regional market. The cable includes at least one optical fiber pair for supporting bidirectional communication between the first and second cable stations. At least one repeater is located along the optical transmission cable. The repeater includes at least two optical amplifiers each providing optical gain to one of the optical fibers in the optical fiber pairs. The optical gain is in a range from about 12 to 20 dB.

### STATEMENT OF RELATED APPLICATIONS

This application claims the benefit of priority to U.S. Provisional Patent Application Ser. No. 60/557,343, filed Mar. 29, 2004, entitled “Method For Commoditizing Elements of Previously Specialized Communications Link,” which is hereby incorporated by reference as if repeated herein in its entirety, including the drawings.

This application is related to U.S. patent application Ser. No. 10/870,327, filed Jun. 17, 2004, entitled “Submarine Optical Transmission Systems Having Optical Amplifiers Of Unitary Design”, and U.S. patent application Ser. No. 10/739,929, filed Dec. 18, 2003, entitled “Method For Commoditizing Elements of Previously Specialized Communications Links,” which are hereby incorporated by reference as if repeated herein in their entirety, including the drawings.

### FIELD OF THE INVENTION

The present invention relates generally to optical transmission systems, and more particularly to an undersea optical transmission system suitable for the regional undersea market

### BACKGROUND

The undersea optical telecommunications market comprises an exemplary vertically integrated business. This market is segmented into short-haul and long-haul operations. Short-haul, or repeater-less systems employ links without powered in-line amplification (hence the term repeater-“less”). Short-haul links typically rely on high optical signal launch power from shore to overcome any inherent loss in the line. Very short point-to-point or lateral/spur network topologies are typically implemented using repeater-less technologies. This solution is attractive because of the lower capital costs that result from the elimination of line amplification as well as the associated power supply and power-carrying elements in the undersea cable.

Repeater-less systems are generally limited to links of about 250 km in length. A maximum upper limit of 400-450 km is observed in practice because the line loss, which scales with distance, outstrips available line gain, the ability to launch more power into the line, and the ability of the system to resolve the received optical signal. As a result, repeater-less networks often are forced to incorporate less desirable network landing points, from political or economic standpoints, because of the inherent distance limitation imposed by the underlying non-amplified technology.

By comparison, the long-haul undersea market segment is addressed by highly-engineered technical solutions that are custom designed for each application. In this market segment, very sophisticated transmission techniques are employed to maximize bandwidth capacity and system reach. While the technology used is highly capable, it is also complex and time-consuming to design, test and deploy. Initial capital costs in long-haul systems tend to be very high, although per-bit transport costs are often attractive if the systems are built-out to maximum design capacity through Dense Wavelength Division Multiplexing (DWDM) technology where many data streams at varying wavelengths are simultaneously carried on the same line.

Long-haul technology generally is not economically scalable downwards to systems having shorter length and capacity requirements. As bandwidth demand is less on shorter regional routes compared with the big transoceanic “pipes,” high design capacity is not available to drive the favorable economics associated with the long-haul technology. And, as long-haul technology is expressly designed to meet the long-distance and large bandwidth capacity demanded in the sector, it is simply not possible from feature set and engineering viewpoints to decontent a long-haul platform to meet the more modest requirements of the regional market.

For any new business trying to enter either of these markets, there are significant barriers to entry, including but not limited to high capital investment, long time to market, and large equipment purchases for inventory, which can be obsolete technology in a short period of time.

The present invention is therefore directed to the problem of developing a method and apparatus for enabling a business to enter these markets rapidly and without necessarily satisfying existing barriers to entry.

### SUMMARY OF THE INVENTION

The present invention relates to a method for providing an undersea optical communications system. The method includes providing first and second land-based cable stations. At least one of the cable stations includes power feed equipment (PFE) supplying electrical power to the cable at a voltage of no more than about 6 kv. The PFE is located in at least one of the cable stations. An undersea WDM optical transmission cable is provided that has a length corresponding to those required in the undersea regional market. The cable includes at least one optical fiber pair for supporting bidirectional communication between the first and second cable stations. At least one repeater located along the optical transmission cable is also provided. The repeater includes at least two optical amplifiers each providing optical gain to one of the optical fibers in the optical fiber pairs. The optical gain of the amplifiers ranges from about 12 to 20 dB.

In accordance with one aspect of the invention, an optical interface device is provided to accept a plurality of types of commodity-based terrestrial terminal equipment. The optical interface device provides optical-level connectivity between the transmission cable and any of the commodity-based terrestrial terminal equipment.

In accordance with another aspect of the invention, at least one of the first and second cable stations further includes submarine line terminal equipment (SLTE) for processing terrestrial traffic received from an external source. The SLTE includes terrestrial optical transmission equipment receiving the terrestrial traffic and generating optical signals in response thereto. An optical interface device provides signal conditioning to the optical signals received from the terrestrial optical transmission equipment so that the optical signals are suitable for transmission through the optical fibers located in the transmission cable.

In accordance with another aspect of the invention, the transmission cable has a length less than about 5000 kilometers.

In accordance with another aspect of the invention, the transmission cable has a length between about 350 km and 4000 km.

In accordance with another aspect of the invention, the repeater includes a housing formed from an undersea cable joint housing.

In accordance with another aspect of the invention, each of the optical amplifiers has a bandwidth of less than about 28 nm.

In accordance with another aspect of the invention, the optical interface device further provides line monitoring functionality.

In accordance with another aspect of the invention, an undersea WDM optical transmission system is provided. The system includes first and second land-based cable stations, at least one of the cable stations includes power feed equipment (PFE) supplying electrical power to the cable at a voltage of no more than about 6 kv or less. The PFE is located in at least one of the cable stations. The system also includes an undersea WDM optical transmission cable having a length corresponding to those required in the undersea regional market. The cable includes at least one optical fiber pair for supporting bidirectional communication between the first and second cable stations. At least one repeater is located along the optical transmission cable. The repeater includes at least two optical amplifiers each providing optical gain to one of the optical fibers in the optical fiber pairs. The optical gain is in a range from about 12 to 20 dB.

### BRIEF DESCRIPTION OF THE DRAWINGS

FIG. 1 depicts an exemplary embodiment of an undersea telecommunications system according to one aspect of the present invention.

FIG. 2 depicts a functional block diagram of a cable station.

### DETAILED DESCRIPTION

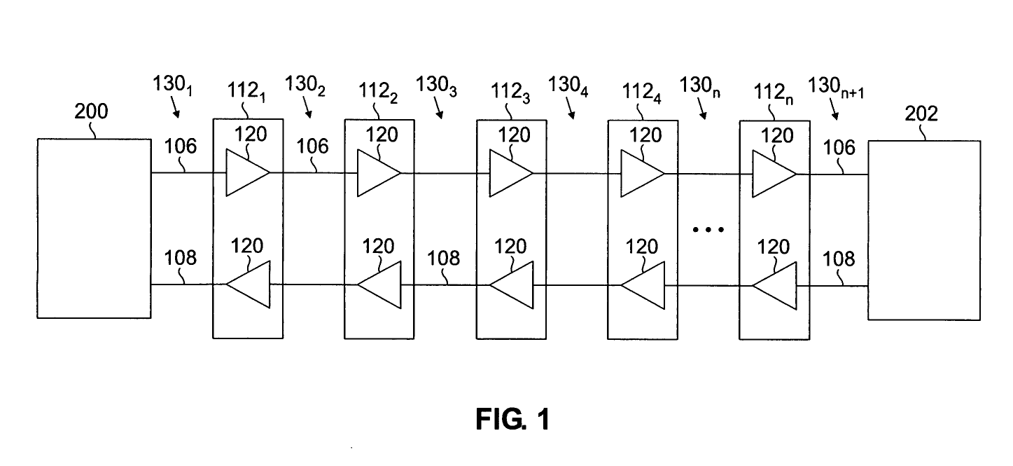

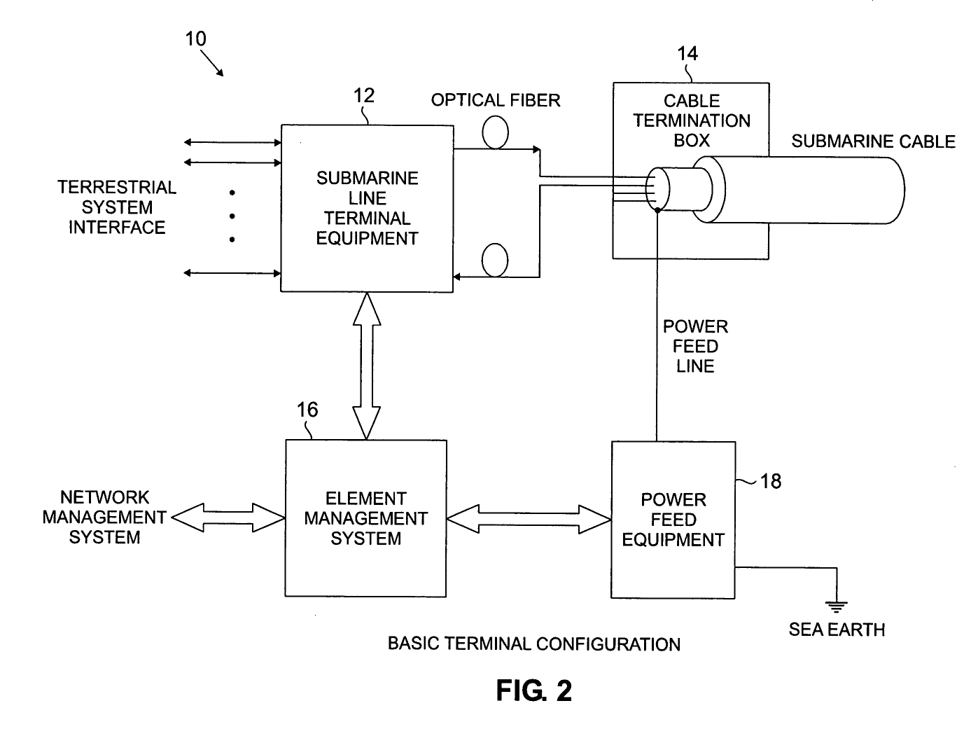

FIG. 1 shows a simplified block diagram of an exemplary wavelength division multiplexed (WDM) transmission system in which the present invention may be employed. The transmission system serves to transmit a plurality of optical channels over a pair of unidirectional optical fibers 106 and 108 between cable stations 200 and 202. Optical fibers 106 and 108 are housed in an optical cable that also includes a power conductor for supplying power to the repeaters. Cable stations 200 and 202 are of the type depicted in FIG. 2. The transmission path is segmented into transmission spans or links 130₁, 130₂, 130₃, . . . 130ₙ₊₁. The transmission spans 130, which are concatenated by repeaters 112₁, 112₂, . . . 112ₙ can range from 40 to 120 km in length, or even longer if Raman amplification is employed. The repeaters include optical amplifiers 120 that connect each of the spans 130. It should be noted that the invention is not limited to point-to-point network architectures such as shown in FIG. 1 but more generally may encompass more complex architectures such as those employing branching units, optical mesh networks, and ring networks, for example.

A functional block diagram of a cable station is shown in FIG. 2. The cable station 10 includes submarine line terminal equipment (SLTE) 12, power feed equipment (PFE) 18, and an element management system (EMS) 16 and a cable termination box (CTB) 14. The SLTE 12 converts terrestrial traffic into an optical signal that is appropriate for an undersea transmission line. The power-feed equipment 18 electrically powers all the active undersea equipment, most notably the repeaters. The EMS 16 allows the system operator to configure the system and to obtain information regarding its status. The CTB 14 terminates the undersea cable and physically separates the cable into optical fibers and the power-feed line and may also serve as a monitoring point for the cable. Additional details concerning cable stations may be found in chapter 10 of “Undersea Fiber Communication Systems,” J. Chesnoy, ed. (Academic Press, 2002).

On the transmit side, the SLTE 12 receives traffic such as an STM signal from a terrestrial terminal that is generally located in a Point of Presence (PoP). The SLTE 12 converts each wavelength of the optical signal to an electrical signal and encodes it with FEC. An electrical to optical unit modulates a continuous wave light from a laser with the electrical signal to generate an optical line signal at each wavelength, which is then optically amplified. The amplified wavelengths may undergo signal conditioning such as dispersion compensation before (or after) being multiplexed together and sent out on the undersea transmission cable. The receive side of the SLTE 12 operates in a complementary manner. The SLTE 12 may also performing line monitoring to determine the status and health of the transmission path. For example, the SLTE 12 may employ a COTDR arrangement to monitor and measure the optical loss of the transmission path.

The PFE 18 is designed to provide a stable DC line current to the submerged portion of the transmission system. The repeaters 112 are powered in series by the PFE 18 located in the cable stations. The entire submerged plant operates at the same DC line current and the PFE must provide sufficient voltage to power all devices at that line current. Line currents and system voltages are typically up to 2000 mA and 15 kV, respectively. The power is delivered to the submerged plant along a copper conductor located within the optical cable, which typically has an impedance of between about 0.5 and 1.5 ohm/km. A large fraction of the power provided by the PFE is wasted as ohmic heating in the cable and repeaters. By way of example, in a long-haul transmission system 7000 km in length with a system voltage of about 16 kV and a line current of 1000 mA, about 7 kW of the 16 kW system load would be lost to ohmic heating. Zener diodes located in the repeaters 112 convert the line current to voltage to power the electronics associated with the optical amplifiers located in the repeaters.

The present inventors have recognized that the current suppliers of undersea or submarine optical transmission systems do not make a product that is technologically or economically appropriate for the regional undersea market space (e.g., the space defined by systems having lengths less than about 5000 km and more particularly having lengths between about 350 and 4000 km). The current offerings are overly complex and expensive. This is because the current providers (incumbents) must also supply product for the transoceanic (i.e., about 5000 to 10000 km) cable market. Systems developed for the more technologically demanding transoceanic market are sold in the regional market instead of a specifically designed regional product. For instance, transoceanic cables are composed of highly optimized, state of the art, components and subsystems in order to deal with the combined effect of ASE noise accumulation, dispersion and dispersion slope, nonlinear index of refraction and PMD. The impact of all of these impairments grows with system length. To the extent possible the impact of these effects has been minimized in transoceanic systems through careful engineering of the optical fiber and optical amplifiers. Mitigation of the residue of these deleterious effects is accomplished in the transmitters and receivers, which are as a result generally highly complex. Such complexity and sophistication is not required of a regional undersea link. However the incumbents nevertheless use transoceanic equipment, decontented a bit perhaps, for regional systems. This makes the regional offering much more expensive than it has to be. The present invention provides a market specific product for the regional undersea market space.

In the past the economics of using high performance transoceanic equipment for regional links was arguably justifiable. Before the advent of wavelength division multiplexing (WDM) all undersea cables carried a single optical channel per fiber. In order to keep the wet plant simple as much as possible of the link's overall complexity was shifted to the shore-based subsystems. Hence, the terminal equipment was designed and optimized to cope with much of the impairments due to the fiber; dispersion, PMD, and nonlinear index of refraction. No matter how complex, the terminals always represented a small fraction of the overall cost of a transoceanic cable. For single channel regional cables the terminal costs, while a larger fraction of the total cost, were still not significant enough to warrant concern.

Since the advent of WDM the number of channels a fiber can carry has increased two orders of magnitude. With this many channels per fiber (and with several fibers per cable) the economics of regional undersea links changes considerably. Now the cost of terminals, one for each wavelength channel, has a significant impact on the total price. Due to the enormous cost and complexity of building and installing a transoceanic cable it makes economic sense to make them as wide-band as possible so that they are able to carry as many wavelength channels per fiber as possible. This entails an amplifier design that requires substantial electrical power. The electrical power is needed to run semiconductor lasers that pump the erbium fiber amplifiers located in the repeaters, which are inserted periodically in the cable to restore the optical signal power levels. The gain band of erbium is relatively flat over about a 25-28 nm bandwidth. If a greater bandwidth (typical state-of-the-art transoceanic cables have bandwidths of about 32 to 36 nm) is used, gain flattening filters are required that introduce significant amounts of excess loss in the amplifier (up to 9 dB). This loss has to be compensated by providing more pump power, which in turn means more electrical power is required.

For transoceanic cables it also makes sense to incorporate as many fiber pairs as possible in the cable (the cable, without fiber, and the repeater housings constitute the bulk of the wet plant cost). Four to eight , fiber pairs are typical for transoceanic cables. The amount of electrical power required by each repeater impacts the electrical design of the cable. Typically a fixed voltage is dropped at each repeater, so a greater power requirement at each repeater translates into a higher current. To carry high currents at high voltages over many thousands of kilometers without significant dissipation of power in the cable itself requires a substantial copper conductor. This is expensive. Voltages required for transoceanic cables are of the order 7 kV to 15 kV, which requires a thick insulating layer to prevent shorting (to an ocean ground). Moreover, the housings required to contain the 4 or 8 optical amplifier pairs becomes large and quite heavy (a typical conventional repeater housing weighs between about 700 and 1000 lbs.). This much weight requires a stronger cable just to support the housings during deployment. Of course, stronger cables are more expensive.

In summary, in going from a single channel design to a WDM design the following changes in systems design arise; the number of terminals per fiber goes from one to as many as 96, the electrical power consumption per amplifier of the repeater increases by at least a factor ten (e.g., 30 mW per amplifier to 300 mW per amplifier) and the copper content of the cable increases to carry the current at low loss. A stronger cable with more electrical insulation is also required.

Of course, the transformation to WDM did not just take place in submarine cable systems. The same transformation impacted terrestrial network design, and as a result, transmission equipment. Point to point terrestrial links greater than 600 km and up to about 1500 km were installed. Prior to 1997 a substantial majority of the terrestrial links were less than about 360 km long and virtually none of the remaining links were longer than about 600 km. However, over the next few years there were terrestrial terminals capable of driving signals over terrestrial links greater than 3000 km long.

A terrestrial terminal capable of driving signals over 3000 km links can easily drive a 4000 km submarine link for the following reason. Terrestrial links, because they are frequently made with legacy fiber and have large spacings (about 100 km or 20-23 dB) between repeaters, will always perform worse than a link designed using currently available fiber with more closely spaced repeaters. (In addition to having high loss and high dispersion, most legacy terrestrial fiber also has high PMD). Hence the present inventors realized that terrestrial terminals, while not necessarily offering the same high performance as transoceanic submarine terminals, could be appropriate for the submarine regional market (e.g., links of about 350 km to 4000 km in length).

A primary reason undersea terminals are significantly more complex than terrestrial terminals is that the undersea terminals require less common modulation formats like chirped RZ or dispersion managed solitons, which require more modulators and drive electronics than the standard terrestrial terminals, which use the more common, and simpler, NRZ modulation format. Terrestrial terminals are produced by many companies and are produced in significantly greater quantities than submarine terminals. Hence competition and volume can be expected to drive down their prices while improving their quality at a greater rate than submarine terminal equipment.

Accordingly, in light of the transformation to WDM and the advances in terrestrial terminal design, the design of a regional submarine or undersea link can be reworked to create a market specific design that is a fraction of the cost of a design that uses transoceanic cable and terminal equipment for the same link.

The following analysis examines the requirements of a regional submarine cable system in more detail. Such systems have a length of less than about 5000 km, and more particularly between about 350 km and 4000 km. Each optical fiber has a capacity to support between 1 and 64 channels at a bit rate of up to about 10 GB/s for each channel. The cable includes 1 or 2 fiber pairs, but generally no more. Cost considerations are also very important: the lower the cost, the larger the potential market. Cost sensitivity is particularly acute because many of the service providers that purchase regional submarine cable systems are not the deep-pocketed global network owners that often purchase transoceanic systems.

Next, consider the impact of the aforementioned requirements of a regional system design on the optical amplifiers. Sixty-four channels at a bit rate of 10 GB/s can easily be contained within an amplifier bandwidth of about 25.2 nm. By choosing amplifier gains between about 10 dB and 16 dB and a bandwidth between 1535 and 1561 nm, the erbium gain will be easy to flatten without significant loss of power (e.g., less than about 1 dB of loss). Amplifiers with these gains can support signals over span lengths of about 50 to 80 km. Since virtually all the pump power is being used for gain the amplifier is electrically efficient. Accordingly the total power out of the amplifiers can be limited to a range of about 12-20 dBm, and more particularly to about 15 dBm. This is adequate to provide the necessary performance and yet requires only about 125 mW of pump power. This is well under the rated power of laser diodes available today. Hence, low electrical power consumption is achieved and the reliability of the pump is increased by running it at less than its maximum capacity.

This regional system design of the present invention also has the advantage of adding performance margin. For a link of a given length the OSNR will be improved when more amplifiers of low gain are employed rather than fewer amplifiers with commensurately higher gain. By having low power consumption amplifiers in the cable and limiting the number of amplifiers to 4 per repeater, the current and voltage carrying requirements of the cable are greatly relaxed. The maximum required voltage is probably about 2 kV to 3 kV and the required current less than half that of a transoceanic cable. Accordingly, a PFE that supplies about 6 kv or less should be satisfactory for most purposes. A specially designed regional cable will have a lower copper content and less electrical insulation. With only 4 amplifiers per repeater a very small housing can be used for the repeater. A smaller housing will also be significantly lighter. This in turn relaxes the strength requirement on the cable. This leads to a reduced cable and repeater cost.

Some of the extra performance margin gained by using amplifiers designed in accordance with the present invention can be reallocated to allow the use of terrestrial terminal equipment for the more expensive and highly customized submarine terminal equipment. Another advantage of using terrestrial terminal equipment in regional undersea links is that the undersea link now can be seamlessly integrated into the terrestrial networks it serves. The cable owners can use terminal equipment from the same vendors that supply the rest of their networks. This reduces the cost of personnel training and equipment maintenance for the owners.

The rest of the extra performance margin can be re-allocated to relax the specification of the optical components used in the repeater. Since the margin of the transmission line is tightly coupled to the performance of the individual optical components used within the amplifier it is possible to relax the component specifications significantly while still maintaining excellent transmission performance over the system's rated lifetime. This leads to further cost savings as well as a greatly increased ease of manufacture. One example of this is in the design of the gain flattening filter (GFF) that is used to control the shape of the optical signal spectrum as it exits the amplifier. For a GFF that is designed to be used in a transoceanic system it is important to carefully control the shape of the filter's insertion loss function over the entire operating temperature range. This is due to the fact that the filter suffers a temperature dependent frequency shift on the order of 10 pm/° C. To counter this effect some manufacturers have developed athermal packaging that will limit this frequency shift to less than approximately 40 pm over the entire operating temperature range of −5 to +70° C. However, this added packaging can add significant cost and introduce unwanted failure mechanisms to an otherwise very simple and robust optical component. By utilizing the extra performance margin gained by focusing on regional systems the need for the athermal package is avoided and temperature induced frequency shifts can be tolerated on the order 350 pm. In addition, the GFF can now be handled and stored just as any other fiber employed in the amplifier housing, thereby providing greatly enhanced mechanical design flexibility.

The following sections set forth some examples of the various hardware subsystems that may be employed in a regional undersea optical communications system that is designed in accordance with the present invention.

Small Form Factor Optical Line Amplifier

U.S. patent application Ser. Nos. 10/687,547 and 10/800,424 disclose examples of a small form factor optical line amplifier that may be employed in the present invention, which are hereby incorporated by reference as if repeated herein in their entirety, including the drawings. The optical line amplifier 14, 16 comprises a small form factor device that integrates into existing submarine qualified pressure and tension housings produced by established suppliers in the submarine space. In one embodiment of the invention the existing submarine qualified pressure and tension housing is conventionally employed to house a submarine cable joint.

The repeater of the present invention employs a conventional erbium-doped fiber amplifier (EDFA) design, in which the amplifier bandwidth is carefully matched to the capacity requirements of the target market. Low parts count, the use of existing submarine-qualified components, and the judicious use of active controllers simplifies the amplifier design to increase , reliability and manufacturability and sharply reduce cost. When deployed in a line designed according to one aspect of the present invention, the amplifier avoids the necessity for bulk gain shape adjustments or dispersion compensation on a per amplifier basis. This results in an amplifier that radically simplifies system integration prior to deployment and increases system maintenance flexibility with a substantial reduction in both as-deployed and as-maintained system cost.

In some embodiments of the present invention, the amplifiers are preferably configured to consume very low power to increase the inherent reliability of the pump lasers, reduce thermal loads, and lessen the power producing and carrying requirements on the DC power supply and undersea cable, respectively. Such a design not only increases overall amplifier reliability, but also substantially lowers costs in the cable because both the power conductor (typically formed from copper) and the dielectric sheathing (typically a medium or high-density polyethylene) can be made smaller in size. When configured as a full up repeater, the ultra-small-form-factor repeater of the present invention generates very small amounts of waste heat and thus can be stored in shipboard cable “tanks” or on deck without external cooling. Such features enhance installation ease while lowering overall costs.

Optical Line Interface

A land-based optical line interface (“OLI”) enables a variety of unmodified terrestrial grade terminal products from multiple vendors to drive the undersea-amplified line. The OLI fits between the terminal equipment and the amplified line to provide optical signal conditioning and grooming at both the launch and receive end of the system. In addition, the OLI provides the required line monitoring, power feed, and optical service channel functionalities that are unique to the undersea telecommunications environment. The OLI plus the terminal serves as the SLTE 12 shown in FIG. 2. Examples of an OLI that may be employed is shown in U.S. patent application Ser. Nos. 10/621,028 and 10/621,115, which are hereby incorporated by reference as if repeated herein in their entirety, including the drawings.

In its interface role, the OLI ensures that the terminal equipment—independent of terminal vendor, modulation format, launch power and other characteristics—successfully transmits and receives data over the undersea, amplified line. The OLI conditions the optical signal at both transmitter and receiver to compensate for line impairments, such as chromatic dispersion and cross-phase modulation, as well as to improve signal-to-noise ratio in the end-to-end system. Raman amplification may be provided in the OLI to increase system reliability and lower costs by increasing the distance from shore to the first repeater, thereby reducing incidents of external aggression close to shore while simultaneously eliminating or the reducing the need for repeater burial.

Terminal

As previously mentioned, the terminal equipment employed in the regional submarine system of the present invention can be conventional land-line terminal equipment. This is another aspect of the present invention, in that many types of pre-existing terminal equipment can be employed, enabling the system designer to purchase the most cost effective terminal equipment at the time. Moreover, this enables the system operator and builder to avoid maintaining supplies of terminal equipment, thereby reducing the inventory costs associated with this business. As such, this element of the system can be a commodity item. Examples of commodity-based terminal equipment that are currently available and which may be used in connection with the present invention include, but are not limited to, the Nortel LH1600 and LH4000, Siemens MTS 2, Cisco 15808 and the Ciena CoreStream long-haul transport products. The terminal equipment may also be a network router in which Internet routing is accomplished as well the requisite optical functionality. Moreover, the terminal equipment that is employed may conform to a variety of different protocol standards, such SONET/SDH ATM and Gigabit Ethernet, for example.

In some embodiments of the invention the terminal equipment need not be conventional land-line terminal equipment. Rather, the terminal equipment may be pre-existing undersea terminal equipment available from third party vendors. Such equipment may be available from inventory and hence may prove to be the most cost effective terminal equipment at the time. Significantly, this pre-existing terminal equipment is customized for the third party vendor's own undersea transmission system and not for the regional undersea market addressed by the present invention.

Although various embodiments are specifically illustrated and described herein, it will be appreciated that modifications and variations of the invention are covered by the above teachings and are within the purview of the appended claims without departing from the spirit and intended scope of the invention. For example, the methods and designs set forth herein are applicable to markets other than the undersea telecommunications market used in the above description. Furthermore, this example should not be interpreted to limit the modifications and variations of the invention covered by the claims but is merely illustrative of possible variations.

1. A method comprising:
providing first and second land-based cable stations, at least one of the cable stations including power feed equipment (PFE) supplying electrical power to the cable at a voltage of no more than about 6 kv, said PFE being located in at least one of the cable stations;
providing an undersea WDM optical transmission cable having a length corresponding to those required in the undersea regional market, said cable including at least one optical fiber pair for supporting bidirectional communication between the first and second cable stations; and
providing at least one repeater located along the optical transmission cable, said repeater including at least two optical amplifiers each providing optical gain to one of the optical fibers in the optical fiber pairs, said optical gain being in a range from about 12 to 20 dB.

2. The method of claim 1 further comprising the step of providing an optical interface device to accept a plurality of types of commodity-based terrestrial terminal equipment, said optical interface providing optical-level connectivity between the transmission cable and any of said commodity-based terrestrial terminal equipment.

3. The method of claim 1 wherein at least one of the first and second cable stations further includes:
submarine line terminal equipment (SLTE) for processing terrestrial traffic received from an external source, said SLTE including terrestrial optical transmission equipment receiving the terrestrial traffic and generating optical signals in response thereto; and
an optical interface device providing signal conditioning to the optical signals received from the terrestrial optical transmission equipment so that the optical signals are suitable for transmission through the optical fibers located in the transmission cable.

4. The method according to claim 1, wherein said transmission cable has a length less than about 5000 kilometers.

5. The method according to claim 1, wherein said transmission cable has a length between about 350 km and 4000 km.

6. The method of claim 1 wherein said repeater includes a housing formed from an undersea cable joint housing.

7. The method of claim 1 wherein each of said optical amplifiers has a bandwidth of less than about 28 nm.

8. The method of claim 2 wherein the optical interface device further provides line monitoring functionality.

9. The method of claim 3 wherein the optical interface device further provides line monitoring functionality.

10. An undersea WDM optical transmission system, comprising:
first and second land-based cable stations, at least one of the cable stations including power feed equipment (PFE) supplying electrical power to the cable at a voltage of no more than about 6 kv, said PFE being located in at least one of the cable stations;
an undersea WDM optical transmission cable having a length corresponding to those required in the undersea regional market, said cable including at least one optical fiber pair for supporting bidirectional communication between the first and second cable stations; and
at least one repeater located along the optical transmission cable, said repeater including at least two optical amplifiers each providing optical gain to one of the optical fibers in the optical fiber pairs, said optical gain being in a range from about 12 to 20 dB.

11. The system of claim 10 further comprising an optical interface device to accept a plurality of types of commodity-based terrestrial terminal equipment, said optical interface providing optical-level connectivity between the transmission cable and any of said commodity-based terrestrial terminal equipment.

12. The system of claim 10 wherein at least one of the first and second cable stations further includes:
submarine line terminal equipment (SLTE) for processing terrestrial traffic received from an external source, said SLTE including terrestrial optical transmission equipment receiving the terrestrial traffic and generating optical signals in response thereto; and
an optical interface device providing signal conditioning to the optical signals received from the terrestrial optical transmission equipment so that the optical signals are suitable for transmission through the optical fibers located in the transmission cable.

13. The system according to claim 10, wherein said transmission cable has a length less than about 5000 kilometers.

14. The system according to claim 10, wherein said transmission cable has a length between about 350 km and 4000 km.

15. The system of claim 10 wherein said repeater includes a housing formed from an undersea cable joint housing.

16. The system of claim 10 wherein each of said optical amplifiers has a bandwidth of less than about 28 nm.

17. The system of claim 11 wherein the optical interface device further provides line monitoring functionality.

18. The system of claim 12 wherein the optical interface device further provides line monitoring functionality.
